(19) United States
(12) Patent Application Publication
(10) Pub. No.: US 2022/0286405 A1
(43) Pub. Date: Sep. 8, 2022

(54) METHOD FOR CONTROLLING COMMUNICATION AVAILABILITY IN A CYBER-PHYSICAL SYSTEM

(71) Applicant: NOKIA TECHNOLOGIES OY, Espoo (FI)

(72) Inventors: Saeed Reza KHOSRAVIRAD, Toronto, Ontario (CA); Paolo BARACCA, Stuttgart (DE); Torsten FAHLDIECK, Ditzingen (DE)

(21) Appl. No.: 17/636,055

(22) PCT Filed: Aug. 19, 2019
(86) PCT No.: PCT/EP2019/072144

§ 371 Date: Feb. 17, 2022

(51) Int. Cl. H04L 47/74; H04L 47/76; H04W 28/26

(52) U.S. Cl. CPC H04L 47/74; H04L 47/76; H04W 28/26

(57) ABSTRACT

The present subject matter relates to a method comprising: determining that a communication of data in a cyber-physical system may not fulfil an availability criterion. An emergency schedule of resources may be determined for enabling a communication of further data in the system in compliance with the availability criterion. The emergency schedule of resources may be used for communication of further data in the system in case the communication of the data does not fulfill the availability criterion.

### TECHNICAL FIELD

Various example embodiments relate to computer networking, and more particularly to a method for controlling communication in a cyber-physical system (CPS).

### BACKGROUND

Current standard and product development for 5G new radio ultra-reliable and low-latency communications (5G NR URLLC), and specifically for factory automation use cases, require a communication service availability of 10⁻⁵ to 10⁻⁹ within a limited time budget of 0.5-2 milliseconds. In addition, industrial automation use cases such as motion controls may require a deterministic availability of communication services as high as a nine nines figure, i.e., 10⁻⁹, for periodic traffic patterns.

### SUMMARY

Example embodiments provide a method comprising: determining that a communication of data in a cyber-physical system, using an original schedule of resources for communication in the system, may not fulfil an availability criterion, determining an emergency schedule of resources for enabling a communication of further data in the system in compliance with the availability criterion, using the emergency schedule of resources for communication of the further data in the system in case the communication of the data does not fulfill the availability criterion.

According to further example embodiments, a controller for a cyber-physical system is provided. The controller comprises means configured to perform: determining that a communication of data in the cyber-physical system, using an original schedule of resources for communication in the system, may not fulfil an availability criterion, determining an emergency schedule of resources for enabling a communication of further data in the system in compliance with the availability criterion, using the emergency schedule of resources for communication of the further data in the system in case the communication of the data does not fulfill the availability criterion.

According to further example embodiments, a computer program comprises instructions stored thereon for performing at least the following: determining that a communication of data in a cyber-physical system, using an original schedule of resources for communication in the system, may not fulfil an availability criterion, determining an emergency schedule of resources for enabling a communication of further data in the system in compliance with the availability criterion, using the emergency schedule of resources for communication of the further data in the system in case the communication of the data does not fulfill the availability criterion.

According to further example embodiments, a base station comprises a controller of the example embodiments.

According to further example embodiments, a system comprises multiple base stations of the example embodiments.

### BRIEF DESCRIPTION OF THE DRAWINGS

The accompanying figures are included to provide a further understanding of examples, and are incorporated in and constitute part of this specification. In the figures:

FIG. 1 depicts a diagram of a cyber-physical system;

FIG. 2 is a flowchart of a method for controlling communication in a cyber-physical system in accordance with an example of the present subject matter;

FIG. 3 is a flowchart of a method for controlling communication in a cyber-physical system in accordance with an example of the present subject matter;

FIG. 4A is a block diagram of a cyber-physical system in accordance with an example of the present subject matter;

FIG. 4B is a block diagram of a cyber-physical system in accordance with an example of the present subject matter;

FIG. 5 is a block diagram showing an example of an apparatus according to an example of the present subject matter;

FIG. 6 depicts an example of an access architecture to which the present subject matter may be applied.

### DETAILED DESCRIPTION

In the following description, for purposes of explanation and not limitation, specific details are set forth such as particular architectures, interfaces, techniques, etc., in order to provide a thorough understanding of the examples. However, it will be apparent to those skilled in the art that the disclosed subject matter may be practiced in other illustrative examples that depart from these specific details. In some instances, detailed descriptions of well-known devices and/or methods are omitted so as not to obscure the description with unnecessary detail.

The present subject matter may enable a reliable radio access and a smart, agile and efficient planning of network radio resources to provide high availability for cyber-physical systems (e.g. wireless motion control applications). For example, on the event when a cyber physical application loses communication and enters a survival time, a network and resource planning may make sure that the communication service is available and successful when the survival time expires. The survival time refers to a time period that is tolerated, e.g. by a control application. For example, the survival time may be the time that an application consuming a communication service may continue without an anticipated message. This may meet the strict communication service availability values asserting that the communication service has to be re-stablished with almost 100% guarantee after being unavailable for one survival time.

The present subject matter may be scalable and provide efficient performance as the over-provisioning may not be needed to cover the so called “very worst case”. For example, the present subject matter may increase the availability of the cyber-physical systems, without having to over-provision the physical and infrastructural resources to guarantee a certain packet decoding success rate. For instance, the present subject matter may prevent increasing the number of spatial antennas, increasing the bandwidth to gain in the frequency diversity, or deploying cloud radio access network (C-RAN) based architectures with multiple access points to increase the spatial diversity. Thus, the present subject matter may save resources such as time, frequency, device to device (D2D) links, multiple antennas, etc., which results in an improved efficiency but also low sensitivity to increase a load in the cyber-physical system. The present subject matter may work reliably for low load situations as well as for high load situations.

The availability criterion may, for example, require that a communication of data from one device to another device in the system is performed within a predefined maximum time period and/or the data is not impaired or corrupted.

Devices of the cyber-physical system may be configured to perform respective functions of a distributed automation application (e.g. for factory automation). The devices may be configured to send and receive messages in accordance with their respective functions. The data comprises one or more messages. Each device of the devices may expect to receive a message at a certain point of time. However, a device may not receive a message in time which may thus result in a violation of the availability criterion. The usage of the emergency schedule of resources for communication of further data in the system may enable to continue performing the application in a transparent manner for end users e.g. the end user may not realize that the availability criterion was not fulfilled.

The communication of the data may comprise the submission of the data by one or more source devices to respective one or more target devices. The communication of the data may not fulfil the availability criterion if the data is impaired and/or not received at the one or more target devices and/or received lately at the target devices.

The controller may be an apparatus. According to an example, the availability criterion is not fulfilled if a device of the system starts a survival time counter that is caused by a failed reception of a message at the device.

According to one example, the controller is configured to use the emergency schedule of resources for a recovery time period and to switch to an original schedule of resources for the system after the recovery time period.

The cyber-physical system may have a set of resources that enable data communication between devices of the system. That set of resources of the system are used to determine the emergency schedule of resources and the original schedule of resources. For example, in case of multiple base stations, the set of resources may be shared resources of the base stations and/or resources of a base station that comprises the controller. The set of resources may further comprise infrastructure resources, e.g., a set of relay nodes, a spatial diversity in the form of distributed or co-located multiple antennas.

For example, the data may comprise at least one message sent or expected to be sent by at least one source device of the system to a respective at least one target device of the system. For example, determining that the communication of the data does not fulfill the availability criterion comprises identifying by the controller the at least one target device involved in the communication of the data and initiating an emergency transmission phase for the at least one target device for transmission of next messages in accordance with the availability criterion. The emergency schedule of resources may be used (e.g. as an emergency phase operation) during the emergency transmission phase. The emergency transmission phase may last the recovery time period.

A schedule of resources may for example define which devices (e.g. in accordance with a priority scheme) should be given resources and/or how much resources should be given to send or receive data in the system. The resources may for example include a modulation, channel coding and transmit scheme, data communication rate, radio frequencies, dedicated and on-demand relaying devices, cooperating base stations, etc.

The original schedule of resources may provide resources, for data communication by devices of the system, following predefined priorities e.g. this may define an original state of the system. The emergency schedule of resources may use different priorities, wherein the switching comprises reverting the priorities of the emergency schedule of resources to the original state in case the emergency transmission phase is over.

Limiting the emergency transmission phase to the recovery time period as defined in this example may enable an efficient control of resource scheduling in the system.

According to one example, the recovery time period is a time difference between two consecutive transfers of data to or from a device (target device) involved in the communication of the data. In one example, the recovery time period may be a time difference between two consecutive transfers of application data from the target device. These two transferred data may be received or intercepted by the controller. For example, the two transfers of application data may be performed via a service interface to a 3rd Generation Partnership Project (3GPP) system e.g. to a base station of the 3GPP system.

If more than one target device is involved in the communication of the data e.g. two target devices are expecting to receive messages but did not receive them yet, the recovery time period may be the largest time difference between two consecutive transfers of data from each of the two target devices.

This example may enable an accurate and reliable condition for switching to the original schedule of resources.

According to one example, the means are configured to determine that the communication of the data does not fulfil the availability criterion by determining that the data is not received within a specified time at a device (target device) involved in the communicating of the data.

For example, each of the target device and the controller may be configured to start a survival time counter from a point of time at which a message is expected to be received at the target device but that message has not been received at that point of time. The start of the survival time counter is an indication of the violation of the availability criterion. The present subject matter may guarantee data communication right after a survival time for cyber physical applications. This may be enabled by an urgent planning and immediate action at the network level to guarantee successful communication when the survival time of an application expires.

According to one example, the means are configured to determine that the communication of the data does not fulfil the availability criterion by determining that a device involved in the communicating of the data has started a survival time counter.

According to one example, the data is a downlink data to a device of the system or uplink data from the device or isochronous traffic transaction data.

According to one example, the means are configured to determine that the communication of the data does not fulfil the availability criterion by receiving a negative acknowledgement (NACK) feedback from a device of the system indicating a failure in detection of the data.

According to one example, the means are configured to determine that the communication of the data does not fulfil the availability criterion by failing to decode the data.

According to one example, the means are configured to determine that the communication of the data does not fulfil the availability criterion by losing the access to a communication channel involved in the communication of the data.

According to one example, the means are configured to determine the emergency schedule of resources by: identifying a set of time-frequency resources that can be re-allocated to a device involved in the communication of the data, and/or identifying a set of one or more neighboring base stations, of a base station that serves the device, that can enhance a communication service through multi-node transmission or reception; and/or identifying a set of one or more relay devices of the system with a strong link to the base station that can act as relays between the base station and the device in a cooperative manner, and/or identifying interference-free resources that can be triggered by signaling among base stations and the base station. The identified schedulable resources may be used for determining the emergency schedule of resources.

The relay devices may be used to communicate further data to the target device. The strong link is a link that enables communication of data in accordance with a predefined data communication quality constraint e.g. the data communication quality constraint may require that a rate of the data communication is higher than a rate threshold.

In one example, the identified set of neighboring base stations may each comprise a controller in accordance with the present subject matter. Upon determining that the communication of the data may not fulfill the availability criterion, the controller may notify the controllers of the set of neighboring base stations accordingly, so that the set of neighboring base stations may be used as cooperating transmitters or relays for communication of further data to the target device during the emergency phase.

In one example, resources scheduled for a device that has not started the survival time counter may be re-allocated to the device involved in the communication of the data.

According to one example, the means are configured to use the emergency schedule of resources for communication of further data in the system by at least one of:

scheduling a device involved in the communication of the data over interference-free resources, and using relay devices of the system for communication of further data to the device.

According to one example, the communication of the data is performed as part of a distributed automation application. The distributed automation application enables a factory automation or a process automation.

According to one example, the multiple base stations share resources, wherein a first controller of the system is configured to perform the determining of the emergency schedule of resources by using the shared resources and/or resources of the base station that enables the communication of the data.

These examples may enable that each controller can determine that the communication of data does not fulfil the availability criterion within a cell covered by the base station that comprises the controller. The controller may trigger the emergency phase operation for its own cell. The emergency schedule of resources may be shared and coordinated among all or a group of controllers.

According to one example, a controller of the system is configured to notify one or more other controllers of the system so that the communication of further data to the device is performed through bases stations of the other notified controllers.

The controller in the emergency transmission phase may notify the other controllers about the emergency phase. The notified controllers may also receive a packet that needs to be transmitted in the emergency transmission phase to the target device; allowing them to operate by helping the controller during the emergency phase.

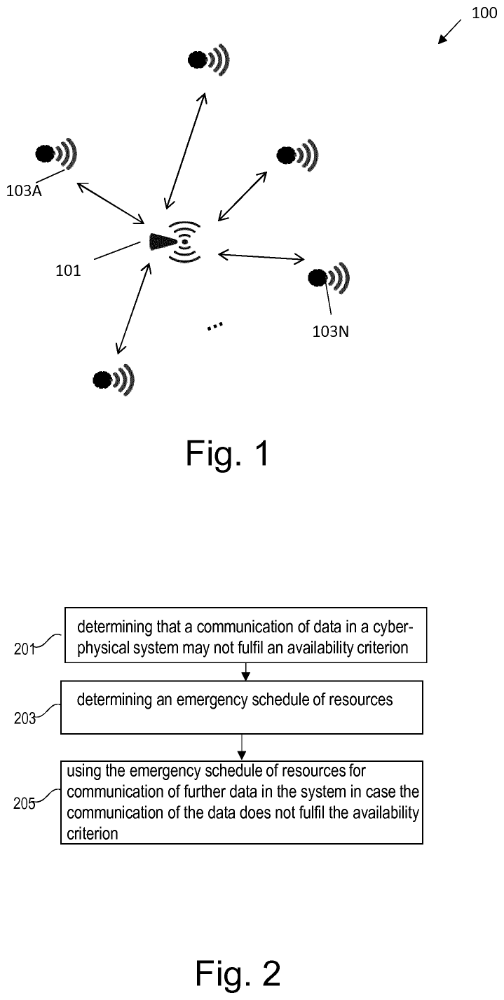

FIG. 1 depicts an example communication system 100. The communication system 100 may for example be a cyber-physical system. The cyber physical system may for example implement a distributed automation application e.g. a cyber physical application. The distributed automation application may for example enable a factory automation e.g. for motion control or mobile robots. In another example, the distributed automation application may enable a process automation e.g. for process monitoring.

The communication system 100 comprises a controller 101. The controller 101 may be configured to access data of devices 103A-N that is communicated through, for example, a radio access network such as 5G network. In one example, the data may be communicated through a network connection which comprises a wireless local area network (WLAN) connection, WAN (Wide Area Network) connection, LAN (Local Area Network) connection or a combination thereof.

Each device of the devices 103A-N may be configured to perform a distributed automation function of the distributed automation application. The devices 103A-N may for example comprise sensors, measurement devices, drives, switches, I/O devices, encoders, user equipment (UE) etc. The functions may contribute toward the control of physical objects.

For example, each device of the devices 103A-N may be configured to communicate data with other devices of the communication system through a network such as the 5G network. For example, the communication of the devices 103A-N of the communication system 100 may be performed through a base station (BS) of the network. The base station may be a serving BS that serves the devices 103A-N. The serving BS may for example be a remote radio head or 5G nodeB (gNB) depending on the deployment. In one example, the controller 101 may be configured to remotely connect to the serving BS. In another example, the controller 101 may be part of the serving BS. For example, the controller 101 may be equipped with a single or multiple BSs, e.g., in a central-RAN architecture. The serving BS may be configured to deliver downlink (DL) messages to every device 103A-N. The delivery may be performed in a limited time T. The controller 101 may be configured to listen to uplink (UL) messages of the devices 103A-N, in a limited time duration of e.g., a fraction of 1 ms.

For example, the communication system 100 may be in an “available” state as long as an availability criterion for transmitted packets is met. The communication system 100 may be unavailable if one or more packets received at one or more target devices 103A-N are impaired and/or untimely. For example, each device of the devices 103A-N may be configured to start a survival time counter from the moment that the device is expecting a message to be received.

For example, the availability criterion may require an expected message to be received within a predefined time. The predefined time may for example be at minimum, the sum of end-to-end latency, jitter, and survival time. The end-to-end latency is the time that takes to transfer a given piece of information from a source to a destination, measured at the communication interface, from the moment it is transmitted by the source to the moment it is successfully received at the destination.

The communication system 100 may be configured to communicate data in accordance with an original or initial schedule of resources that enable to fulfil the availability criterion. However, the availability criterion may not be fulfilled by the communication system 100 in certain circumstances.

The reliability of the communication system 100 may be defined as the percentage of successfully delivered (in both directions) messages. The communication system 100 may be configured to use a diversity of techniques for data transmission in order to meet the stringent requirement on reliability within a limited time budget e.g. for industrial automation. For example, more than a few orders of diversity may be used in order to guarantee a successful transmission in a typical range of signal-to-noise-ratios (SNRs). Furthermore, some of the devices 103A-N may be deployed behind large machines blocking the signal from significant number of access point locations. For example, due to time limitations and the need for highly-reliable feedback signaling, automatic repeat request (ARQ) type retransmission methods may not be used by the communication system 100.

The communication system 100 may cover one or more cells. Each cell of the cells may for example be served by a respective base station of the communication system 100.

FIG. 2 is a flowchart of a method for controlling communication in a cyber-physical system e.g. 100.

In step 201, the controller 101 may determine that a communication of data in the cyber-physical system 100 may not fulfil the availability criterion. The data may be one or more messages. Each message of the one or more messages may, for example, be sent by a respective source device 103A-N to a target device 103A-N of the communication system 100 e.g. in accordance with the distributed automation application. The target device may thus be expecting the message. For simplification of the description only one target device may be considered as involved in the communication of the data but the present subject matter is not limited to one target device.

In a first example, the controller 101 may determine that the cyber-physical system 100 does not fulfil the availability criterion. This may for example be performed by the controller 101 by identifying or predicting the start of the survival time counter for the target device 103A-N. The identification may, for example, be performed for a given messaging direction (e.g., a device communicating according to UL or DL), or based on cycle-time (e.g., a device with an isochronous traffic transaction). The survival time counter commences from the moment that the target device is expecting a message to be received; although the identification of the start of the survival time counter may happen before or after the counter starts.

The identification of the start of the survival time for the target device may for example comprise detecting at least one of the following events or failure indicators.
A NACK feedback received from the target device declaring a failure in detection of an earlier communication attempt.
A failure to decode, by the controller, a message (data or control) from the target device 103A-N. This may be caused by a deep fade/blockage, or strong momentary interference.
The access to a communication channel may be lost, e.g., in an unlicensed band channel where a channel occupancy time of the serving BS is expired, and the listen before talk (LBT) attempt to re-gain channel access fails. This may be performed by determining that a source device that sends the data to the target device has lost the access to the channel before or immediately after sending the data to the target device. In such conditions, an emergency transmission phase may be extended for multiple transfer intervals, e.g., until the serving BS re-gains channel access.

In a second example, the controller 101 may determine that the cyber-physical system 100 is expected to not fulfill (will not fulfill) the availability criterion e.g. determining an anticipated failure. For that, the survival time may be anticipated for the target device 103A-N based on e.g., channel state information (CSI) prediction for the link involving the communication of the data to the target device. In such case, the survival time has not yet started, however, due to the anticipated failure, the controller 101 will prepare for successful communication for the upcoming message.

For example, if more than one target device is involved in the communication of the data e.g. more than one target device has not received its expected message, then at least part of the failure indicators may be detected for each target device of the more than one target device.

In response to determining that the communication of the data in the cyber-physical system 100 may not fulfil the availability criterion, the controller 101 may determine in step 203 an emergency schedule of resources of the system 100 (e.g. no over provisioning may be needed) for enabling a communication of further data in the system in compliance with the availability criterion. The determination of the emergency schedule of resources may enable a preparation and signaling for the emergency transmission phase.

The determination of the emergency schedule of resources may comprise identifying schedulable resources of the communication system 100 that can be used for the emergency schedule of resources. The identified schedulable resources may for example comprise at least one of:
a set of time-frequency resources that could be re-allocated to the target device. These resources can be dynamically or semi-statically identifiable and can be shared among cells or be cell-specific,
a set of neighboring BSs of the serving BS (e.g. remote radio heads or gNBs depending on the deployment) that can enhance the communication service through multi-node transmission/reception, e.g., coordinated multi-point (CoMP),
a set of relay devices of the system 100 with a strong link to the serving BS and that can act as relays between the serving BS and the target device in a cooperative manner. These relaying resources may be semi-statically scheduled and the target device can use those resources for reception of DL transmissions or transmission of UL messages, and
interference-free resources that can be triggered by signaling among BSs. E.g., a set of resources may be prescribed to all nodes for the case of emergency. Transmission of non-urgent messages that are scheduled over the interference-free resources may be dropped during the emergency transmission phase, meanwhile, the target device may automatically know where to look for its message coming out of survival time.

Using the identified schedulable resources, the emergency schedule of resources may be defined. In one example, the schedule may require a lower transmission rate (e.g., a low modulation and coding scheme (MCS)). This may be useful when the serving BS has spare resources to allocate to the target device. Alternatively, the emergency schedule may be defined so that resources scheduled for the rest of the devices in the system 100 may be re-allocated to the target device. For instance, the serving BS may cancel, in accordance with the emergency schedule, the planned transmission to a given device that has a reliable link to the serving BS, and allocate the resources of that given device to the target device. The given device will experience the survival time in a next transmission of a message, however due to the good channel quality to the serving BS, communication availability may be easily recovered.

In another example, the emergency schedule of resources may require to schedule the target device over the interference-free resources.

In another example, the emergency schedule of resources may require that the serving BS triggers a multi-node transmission/reception. The serving BS can inform, in accordance with the emergency schedule, cooperating BSs about the set of PRB/mini-slots over which the cooperative transmission to the target device is scheduled.

In another example, the emergency schedule of resources may further require a cooperative relaying operation. The relaying operation may be triggered by the serving BS. In such case, a pre-defined cooperative procedure (e.g., group radio network temporary identifier (RNTI) addressing a set of relay devices) is deployed prior to the allocation for the target device.

The emergency schedule of resources may be used or applied in step 205 for communication of further data in the system 100 in case the communication of the data does not fulfill the availability criterion. Step 205 may be performed during the emergency transmission phase. For example, step 205 may be performed only during a recovery time period. After the recovery time period the controller 101 may switch to the original schedule of resources for communication in the system 100. The recovery time period may for example be a time difference between two consecutive (successful) transfers of data from a device involved in the communication of the data that did not fulfil the availability criterion.

For example, the communication of the further data comprises communication of data to the target device and to other devices of the system during the emergency phase.

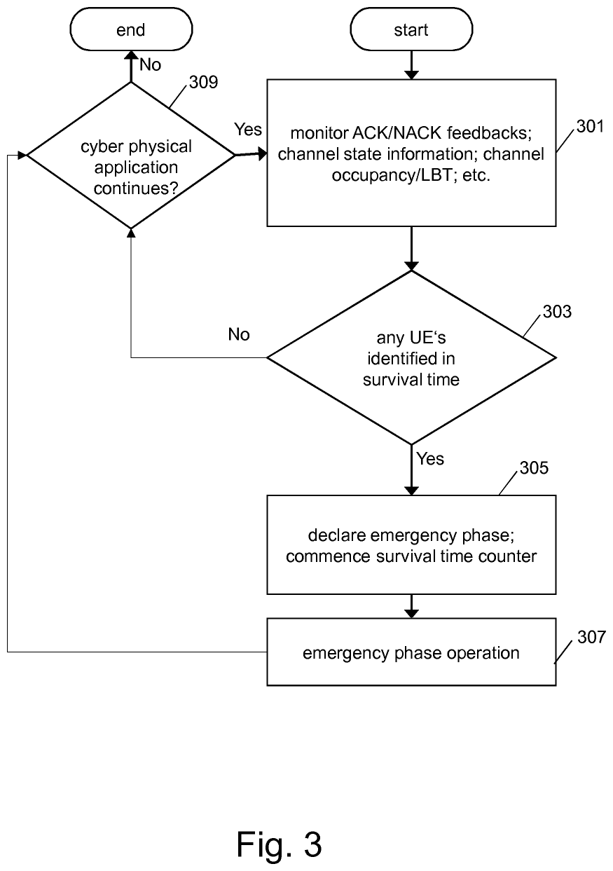

FIG. 3 is a flowchart of a method for controlling communication in a cyber-physical system e.g. 100. The method may enable a signaling and scheduling for communication links that are identified as (or anticipated) to be in a survival time.

In step 301, multiple failure indicators may be monitored. The failure indicators may for example comprise ACK/NACK feedbacks in the communication system 100 or channel occupancy in the communication system 100. This may enable to determine or identify (inquiry step 303) if any UE of the communication system 100 is in survival time.

If at least one UE is identified in the survival time, an emergency transmission phase may be declared and the survival time counter may be started. The survival time counter may start at the start of emergency transmission phase but it counts from the time that the packet was expected to be received at the target device. The network may identify the UE in such condition and initiate the emergency transmission phase for the UE for a next message. For example, the emergency transmission phase can e.g. be initiated by a scheduler and triggered by observation of a failure at the MAC layer.

The operation of the emergency transmission phase may be performed in step 307 such that during the emergency transmission phase, resources of users/cells that are not in a survival time condition may be re-prioritized to guarantee a deterministic success for the next transmission to the identified UE. E.g., resources scheduled for a (potentially cyber physical) UE that is not in survival time may be re-allocated to the identified UE, and/or, neighboring cell BS's may cooperate with the serving BS of the identified UE e.g., in a CoMP transmission manner, to guarantee successful transmission of the next message to/from the identified UE. The priorities of resource scheduling and cell BS cooperation may then be reverted to an original state as soon as the emergency transmission phase is over (e.g., after one successful transfer interval) and survival time situation for the identified UE is resolved.

If none of the UEs of the communication system 100 is identified in survival time, it may be determined (inquiry step 309) if the cyber physical application continues. If the cyber physical application continues, steps 301-309 may be repeated, otherwise the method may end.

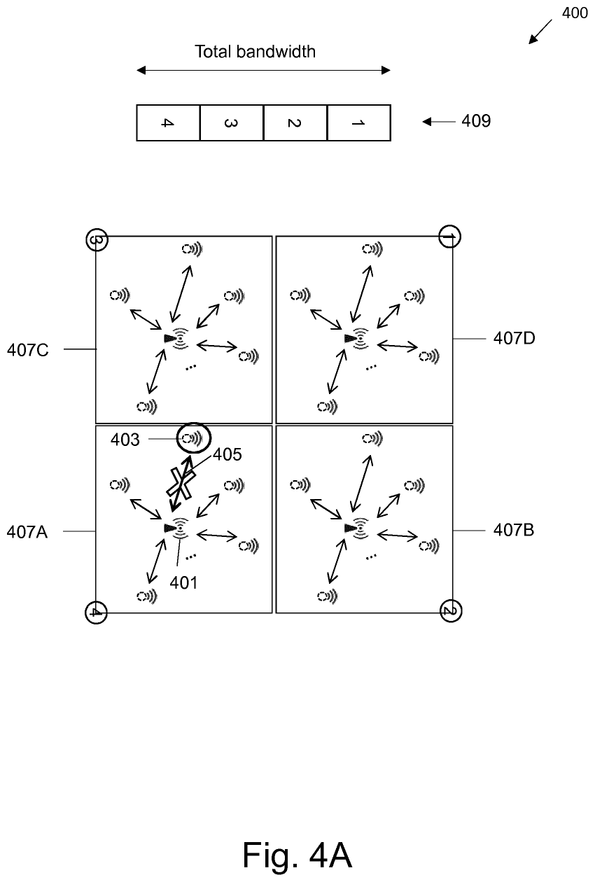

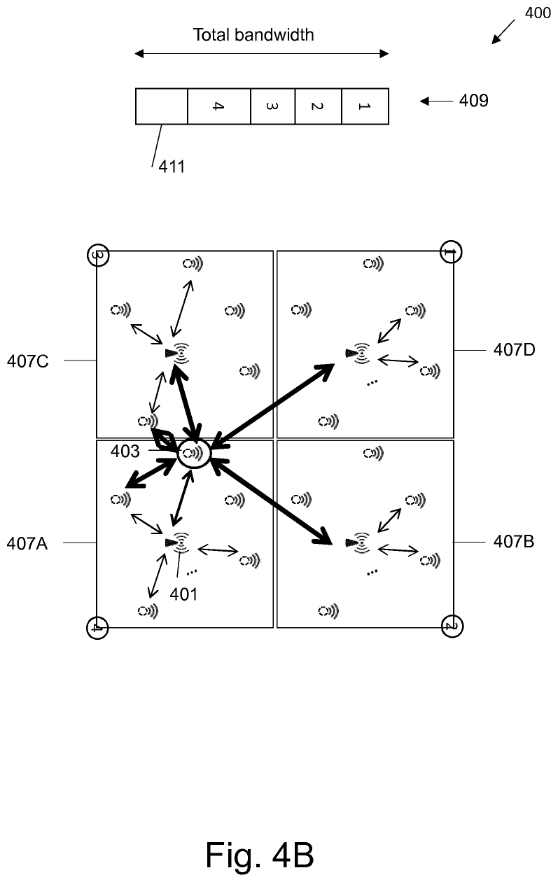

FIG. 4A is a block diagram of a cyber-physical system 400 in accordance with an example of the present subject matter.

The cyber-physical system 400 comprises multiple cells 407A-D (or user clusters), wherein each cell comprises a base station serving multiple devices. FIG. 4A further shows an example bandwidth allocation using a total bandwidth 409 to each cell of the cyber-physical system 400.

For example, the cell 407A comprises a base station 401 and a target device 403 that is identified to be in survival time. As indicated in FIG. 4A, communication of data from the target device 403 to the BS 401 over link 405 is impaired. The target device 403 is identified by the base station 401. This may result in the BS 401 triggering the emergency transmission phase.

FIG. 4B shows how the emergency schedule of resources is used during the triggered emergency transmission phase. The transmission to/from UE's with low priority is dropped in accordance with the schedule and neighboring cell BS's and relay UE's cooperate to guarantee reliable communication with the UE 403 as indicated in FIG. 4B by additional arrows linking the UE 403 to neighboring base stations and relay UEs.

In addition, the total bandwidth 409 may be re-allocated among cells 407A-D and the UE 403 so that emergency resources 411 may be allocated to communication with the UE 403. The re-allocation of bandwidth among the cells 407A-D may be used by prioritizing the UE 403. For example, the portion of bandwidth 411 allocated to all the cells 407A-D is allocated to the UE 403. This can be implemented according to a pre-specified allocation plan when the emergency transmission phase is triggered by the BS 401. The transmission/relaying for the survival of the UE 403 is carried out over the specified resources.

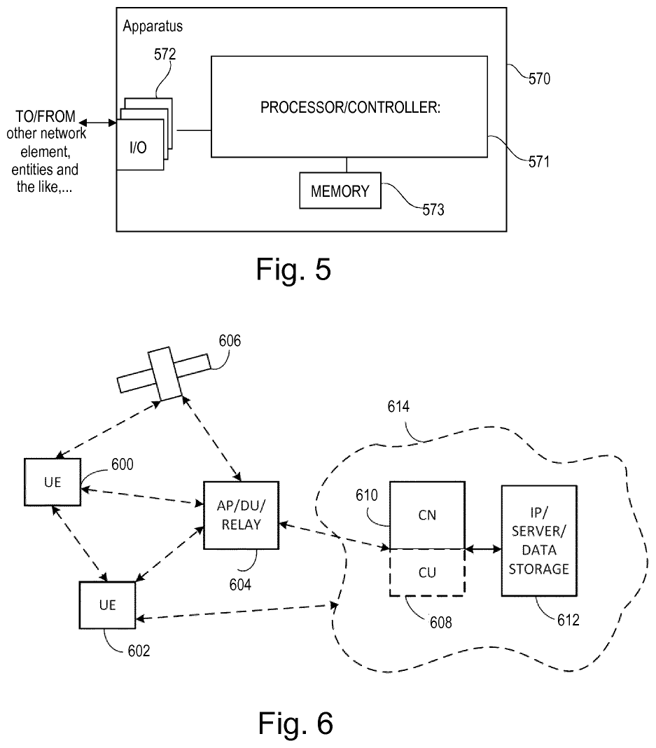

FIG. 5 is a block diagram showing an example of an apparatus e.g. 101 according to an example of the present subject matter.

In FIG. 5, a block circuit diagram illustrating a configuration of an apparatus 570 is shown, which is configured to implement at least part of the present subject matter. It is to be noted that the apparatus 570 shown in FIG. 5 may comprise several further elements or functions besides those described herein below, which are omitted herein for the sake of simplicity as they are not essential for the understanding. Furthermore, the apparatus may be also another device having a similar function, such as a chipset, a chip, a module etc., which can also be part of an apparatus or attached as a separate element to the apparatus, or the like. The apparatus 570 may comprise a processing function or processor 571, such as a central processing unit (CPU) or the like, which executes instructions given by programs or the like related to a flow control mechanism. The processor 571 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 572 denotes transceiver or input/output (I/O) units (interfaces) connected to the processor 571. The I/O units 572 may be used for communicating with one or more other network elements, entities, terminals or the like. The I/O units 572 may be a combined unit comprising communication equipment towards several network elements, or may comprise a distributed structure with a plurality of different interfaces for different network elements. Reference sign 573 denotes a memory usable, for example, for storing data and programs to be executed by the processor 571 and/or as a working storage of the processor 571.

The processor 571 is configured to execute processing related to the above described subject matter. In particular, the apparatus 570 may be configured to perform at least part of the method as described in connection with FIGS. 2 and 3.

The processor 571 is configured to determine that a communication of data in a cyber-physical system e.g. 100 may not fulfil an availability criterion, determine an emergency schedule of resources for enabling a communication of further data in the system in compliance with the availability criterion, and use the emergency schedule of resources for communication of further data in the system in case the communication of the data does not fulfill the availability criterion.

FIG. 6 depicts an example of an access architecture to which the present subject matter may be applied, a radio access architecture based on long term evolution advanced (LTE Advanced, LTE-A) or new radio (NR, 5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

FIG. 6 depicts examples of simplified system architectures only showing some elements and functional entities, all being logical units, whose implementation may differ from what is shown. The connections shown in FIG. 6 are logical connections; the actual physical connections may be different. It is apparent to a person skilled in the art that the system typically comprises also other functions and structures than those shown in FIG. 6.

The embodiments are not, however, restricted to the system given as an example but a person skilled in the art may apply the solution to other communication systems provided with necessary properties.

The example of FIG. 6 shows a part of an exemplifying radio access network. FIG. 6 shows user devices 600 and 602 configured to be in a wireless connection on one or more communication channels in a cell with an access node (such as (e/g)NodeB) 604 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point (AP) etc. entity suitable for such a usage.

A communications system typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 610 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station. The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a CPS (e.g. a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 6) may be implemented. 5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 612, or utilize services provided by them. The communication network may also be able to support the usage of cloud services, for example at least part of core network operations may be carried out as a cloud service (this is depicted in FIG. 6 by “cloud” 614). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 604) and non-real time functions being carried out in a centralized manner (in a centralized unit, CU 608). It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 606 in the mega-constellation may cover several satellite-enabled network entities that create on-ground cells. The on-ground cells may be created through an on-ground relay node 604 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 6 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 6). A HNB Gateway (HNB-GW), which is typically installed within an operator's network may aggregate traffic from a large number of HNBs back to a core network.

1. A controller for a cyber-physical system, the controller comprising:
at least one processor; and
at least one memory including computer program code, the at least one memory and the computer program code being configured to, with the at least one processor, cause the controller to perform:
determining that a communication of data in the cyber-physical system, using an original schedule of resources for communication in the system, may not fulfil an availability criterion;
determining an emergency schedule of resources of the system for enabling a communication of further data in the system in compliance with the availability criterion; and
using the emergency schedule of resources for communication of the further data in the system in case the communication of the data does not fulfill the availability criterion.

2. The controller of claim 1, the at least one memory and computer program code being further configured, with the at least one processor, to use the emergency schedule of recourses for a recovery time period and to switch, after the recovery time period, to the original schedule of resources for communication in the system.

3. The controller of claim 2, wherein the recovery time period is a time difference between two consecutive transfers of data from a device involved in the communication of the data that did not fulfil the availability criterion.

4. The controller of claim 1, the at least one memory and computer program code being further configured, with the at least one processor, to determine that the communication of the data does not fulfil the availability criterion by any one of:
determining that the data is not received within a specified time at a device involved in the communicating of the data;
determining that a device involved in the communication of the data has started a survival time counter;
receiving a negative acknowledgement, NACK, feedback from a device of the system indicating a failure in detection of the data;
failing to decode the data;
losing an access to a communication channel involved in the communication of the data.

5. The controller of claim 1, wherein the data comprises a downlink data to a device of the system or uplink data from the device or isochronous traffic data.

6. The controller of claim 1, the at least one memory and computer program code being further configured, with the at least one processor, to determine the emergency schedule of resources by identifying schedulable resources and using the identified schedulable resources for determining the emergency schedule of resources, wherein the identifying comprises any one of:
identifying a set of time-frequency resources that can be re-allocated to a device involved in the communication of the data;
identifying a set of one or more neighboring base stations of a base station, serving the device, that can enhance a communication service through multi-node transmission or reception;
identifying a set of one or more relay devices of the system with a strong link to the base station that can act as relays between the base station and the device;
identifying interference-free resources that can be triggered by signaling among neighboring base stations and the base station.

7. The controller of claim 1, the at least one memory and computer program code being further configured, with the at least one processor, to use the emergency schedule of resources for communication of further data in the system by at least one of:
scheduling a device involved in the communication of the data over interference-free resources; and
using relay devices of the system for communication of at least part of the further data to the device.

8. The controller of claim 1, wherein the communication of the data is performed as part of a distributed automation application, the distributed automation application enabling a factory automation or a process automation.

9. (canceled)

10. A base station comprising the controller of claim 1.

11. A system comprising multiple base stations of claim 10, the multiple base stations sharing resources, wherein at least one controller of the system is configured to perform the determining of the emergency schedule of resources by using the shared resources and/or resources of the base station.

12. The system of claim 11, wherein the at least one controller is configured to notify one or more other controllers of the system so that a communication of further data to a device is performed through bases stations of the other controllers.

13. A method, comprising:
determining that a communication of data in a cyber-physical system, using an original schedule of resources for communication in the system, may not fulfil an availability criterion;
determining an emergency schedule of resources of the system for enabling a communication of further data in the system in compliance with the availability criterion; and
using the emergency schedule of resources for communication of the further data in the system in case the communication of the data does not fulfill the availability criterion.

14. A computer program embodied on a non-transitory computer-readable medium, said computer program comprising instructions which, when executed in hardware, cause the hardware to perform:
determining that a communication of data in a cyber-physical system, using an original schedule of resources for communication in the system, may not fulfil an availability criterion;
determining an emergency schedule of resources of the system for enabling a communication of further data in the system in compliance with the availability criterion; and
using the emergency schedule of resources for communication of the further data in the system in case the communication of the data does not fulfill the availability criterion.
